(19) United States
(12) Patent Application Publication
(10) Pub. No.: US 2007/0198409 A1
(43) Pub. Date: Aug. 23, 2007

(54) E-MAIL BANK ACCOUNT STATEMENT FOR INTERNET BANKING WHEN CARRYING OUT ONLINE PAYMENTS VIA E-MAIL AND METHOD FOR PREPARING AN E-MAIL BANK ACCOUNT STATEMENT

(76) Inventor: Charles Mason, Bern (CH)

Correspondence Address: DAVID A. GUERRA;INTERNATIONAL PATENT GROUP, LLC, 2025 17TH AVENUE N.W., CALGARY, AB, T2M 0S7, CA

(21) Appl. No.: 10/599,070

(22) PCT Filed: Sep. 20, 2004
(86) PCT No.: PCT/IB04/03065

§ 371 Date: Sep. 19, 2006

(30) Foreign Application Priority Data
Aug. 27, 2004 (CH) 01412/04

(51) Int. Cl. G06Q 40/00

(52) U.S. Cl. 705/42

(57) ABSTRACT

The E-mail bank account statement consists of an E:mail and contains a heading part with a data (3), posting text (4), debit (5), credit (6), value date (7) and balance (8). The posting text (4) is a source of information. The E-mail bank account statement can be used for Internet banking as a general immediate bank account statement containing data for account balancing. The inventive E-mail bank account statement comprises a server script (20) that acts upon the mail server (19) and sends the E-mail bank account statement by using the mail server (19). At the same time, the program (20) takes on the roll of verifying data from the entire data storage (18) and generates the information details for the E-mail bank account statement.

The invention relates to an instant electronic money transfer and corresponding detailed bank account statement via e-mail according to the generic clause of patent claim 1 and a process for the preparation of an instant e-mail payment and bank account statement according to claim 4.

Since the invention of Internet it is known that there is always a certain period of delay in the course taken by the transfer of the money to be electronically transmitted, for example payment by credit cards as well as by Internet banking as well as conventional banking before the payment and the corresponding bank account statement can be delivered. During this period of waiting, in order to protect the user against fraud, bookkeeping errors, computer system errors as well as human errors, particularly having regard to encrypted Internet connection the bank account and credit card owner are inadequately protected because the standard delay period before a detailed bank account statement becomes available for a credit card owner is not less than 20 days. In the event of fraud during this delay period a risk exists of increasing annoyance as well as court proceedings. The trend in Internet banking is that whoever wants a monthly statement of account in paper format must pay therefor. This may cost more than CHF3 per statement per bank per month. Such a high fee and long delay for bank account statements may not only hamper the use of the conventional banking system but may even enable swindlers to commit credit card fraud, etc., occasionally even leading to the total loss of the assets of the bank account. The structure of Internet banking and credit card service offers a certain degree of protection against the aforementioned effects of the lack of a paper bank account statement, back readable data banks and fraud, but is in certain cases inadequate so that additional expedients are required.

The generally know expedients for preventing or mitigating on-line money transfer fraud comprise the delivery of detailed bank account statements, not earlier than 2 working days after the on-line payment delivery, for example, the bank account statement after a payment by way of electronic accounting cannot be called up immediately after the transfer by way of the website of the issuing bank. Which ever way, it takes several days before the account statement can be produced. The disadvantage in the application of the afore described conventional measures against credit card fraud and a reduction of standard delay periods for the delivery of bank account statement reports, as confirmed by experiment, resides in that where such on-line payment needs to be protected, relatively long delays apply and cost are too high so that valuable property may be lost.

It is an object of the invention
to propose a simple, secure and detailed electronic bank account statement which can be delivered instantly via e-mail, for Internet money transfers, which is to protect the on-line payment effectively against swindlers and significantly reduces the long delay periods for the bank account extract, that is to say, to remove the aforesaid disadvantages of the afore described conventional protective measures, thereby to provide advantages, and
to disclose a process for the production of such e-mail bank account statement.

These objects are attained according to the invention
in respect of the e-mail bank account statement by the integers of the characterizing part of patent claim 1, and
in respect of the process for the production by the integers of the characterizing part of claim 4.

According to a particular embodiment of an electronic mail system, the e-mail bank account statement is composed of an address of the issuing bank, title, date, accounting text, debit, credit, currency and balance components, wherein the accounting text provides a descriptive list of bank transfers. As a sub-item the e-mail bank account statement includes applicable legal notices. The contents of the e-mail bank account statement provide a detailed financial report of the bank account movements. This e-mail bank account statement can be produced conveniently within a few minutes.

The advantages attained by the invention reside in that, as confirmed by test, the delivery of the e-mail bank account statement takes place in minutes instead of days after an on-line money transfer. The reduction of the standard delay period for e-mail bank account statements which reaches the credit card bank account and credit card owner within minutes is not attained in respect of speed and detail of the bank statement by any comparable known conventional bank account statement system.

A conventional bank account statement would for the same effect be very costly, approximately thirty fold and sometimes even more than the corresponding attainable costs for the bank account statement according to the invention. The attainable delay reduction for the e-mail bank account statement delivery has the effect that for an e-mail bank account statement which corresponds to the quality requirements of the banking system in the context of on-line money transfer, the resultant fraud, bookkeeping errors and computer errors can be avoided. The proposed e-mail bank account statement for the protection of on-line money transfers can be produced easily and cheaply and can be used economically safely.

In the following the invention will be further elucidated by way of a working example in conjunction with the drawings.

There is shown in:

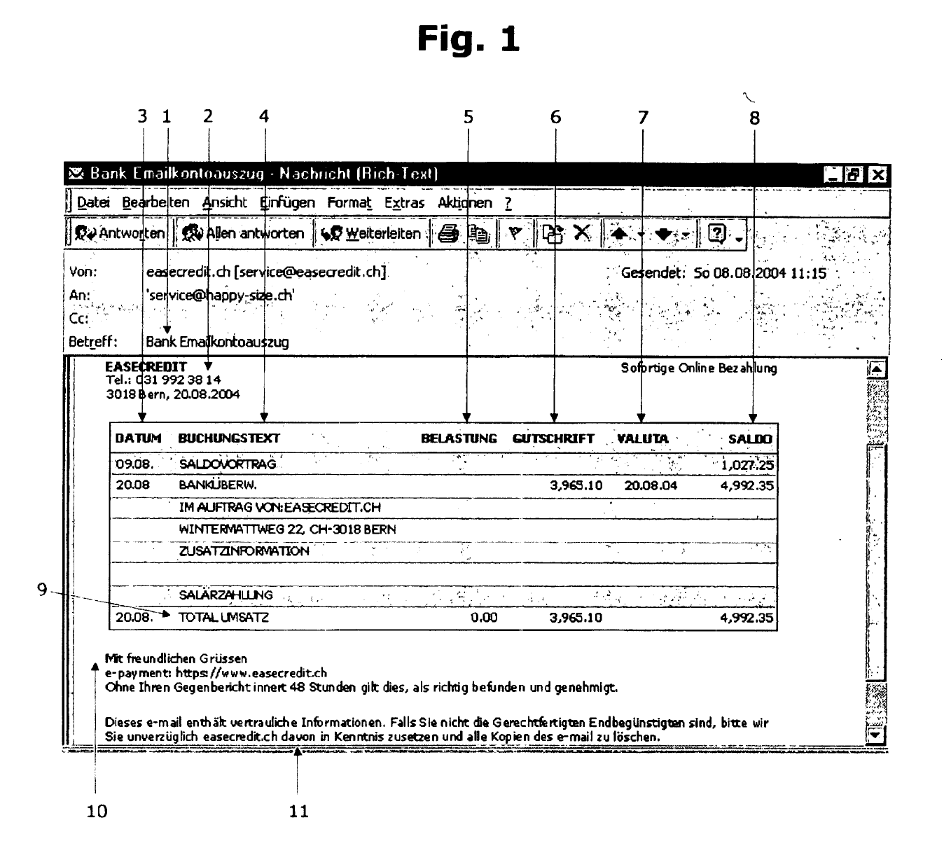

FIG. 1 a perspective view of an e-mail including the e-mail bank account statement according to the invention.

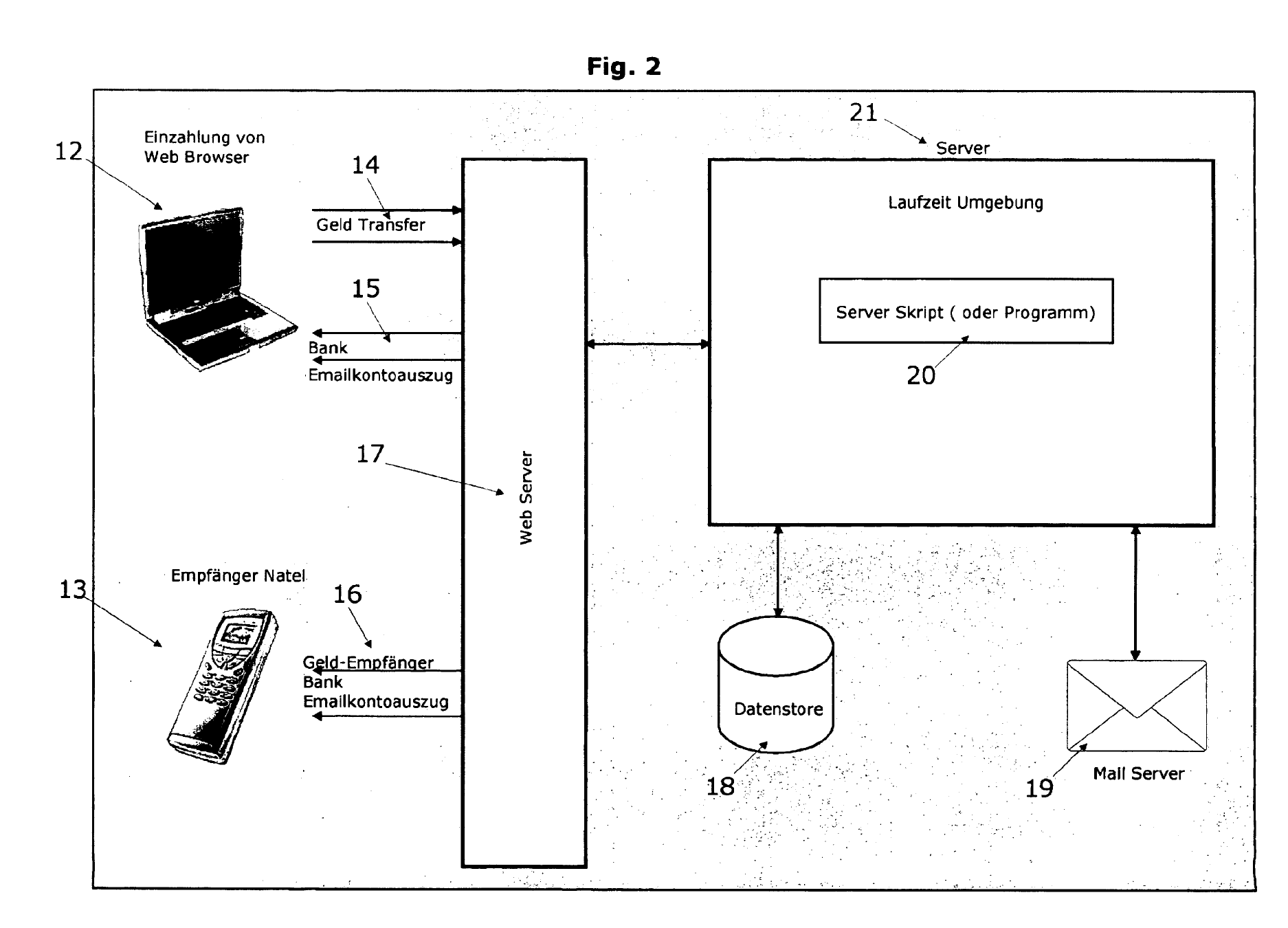

FIG. 2 a perspective view of a web application architecture system for the e-mail bank account statement.

In FIG. 1, 1 denotes a title denoting an e-mail bank account statement. The account numbers can also be given here. Item 2 denotes the name and address of the issuing bank. Items 3 to 8 denote the items: date, accounting text, debit, credit, currency and balance. The accounting text 4 provides for a description as well as balance carried forward, end beneficiary, recipient, initial information, on instructions of:, etc. The balance 8 is shown on the far right side and includes balancing for purposes of an up to date e-mail bank account statement which is useful for the account holder. This is likewise illustrated as turnover 9 under the heading of accounting text 4. The central portion 9 includes a salutation with the name of the bank. The legal paragraph 11 serves to provide legal protection in order to avoid misuse of the e-mail bank account statement as well as notification on data protection.

According to FIG. 2 a web browser 12 is provided by which the money transfer can be actuated and the money recipient 13 denotes a mobile telephone (cellular telephone). Both items 12 and 13 are connected to the item web server 17. The server 21 includes an upper portion server script 20 and in the left hand lower portion data store 18 and in the right hand lower portion mail server 19. The server script or program includes user data for purposes of verification of the user. The data store 18 and the mail server 19 are not directly interconnected. The data store 18 serves for the storage of protected data of the user. The e-mail bank account statement is produced by the mail server 19 only after successful conclusion of the verification process by the program 20. The proposed e-mail bank account statement with its special properties is generated within a few minutes provided the data of the user corresponds to the protected data in the data store 18.

1. Process for issuing an e-mail bank account statement in the context of an on-line money transfer via Internet, characterized in that the accounts statement is transmitted within minutes by the mail server (19) of the bank computer by e-mail to the holder of the debited account.

2. Process according to claim 1, characterized in that the mail server (19) co-acts with the server script (20) of the computer for capturing and processing the required data and the transmission of the accounts statement to a web browser (12).

3. Process according to either of claims 1 and 2, characterized in that an accounts statement is also transmitted to the beneficiary.
